(19) United States
(12) Patent Application Publication
(10) Pub. No.: US 2008/0250395 A1
(43) Pub. Date: Oct. 9, 2008

(54) Method for Producing Documentation

(76) Inventors: Markus Fislage, Leonberg (DE); Christophe Kolb, Gerlingen (DE)

Correspondence Address: KENYON & KENYON LLP, ONE BROADWAY, NEW YORK, NY, 10004, US

(21) Appl. No.: 11/883,980

(22) PCT Filed: Mar. 6, 2006
(86) PCT No.: PCT/EP06/60495

§ 371 Date: Mar. 25, 2008

(30) Foreign Application Priority Data
Mar. 11, 2005 (DE) 102005011247.1

(51) Int. Cl. G06F 9/44

(52) U.S. Cl. 717/123

(57) ABSTRACT

A method for automatically producing documentation for a project, in which at least one architecture description which describes an architecture of the project having individual architecture elements, and detailed descriptions of the architectural elements are integrated using a configuration management tool.

### FIELD OF THE INVENTION

The present invention relates to a method for producing documentation, documentation for a project, a computer program, and a computer program product for carrying out the method.

### BACKGROUND INFORMATION

Up-to-date documentation for a software product is of great importance, in particular in larger teams which produce this software product. Using this documentation, communication overhead, which usually contains further data in addition to the actual useful data, and possibly occurring misunderstandings may be avoided. Providing consistent and comprehensive documentation currently represents a problem in the case of a product that has multiple variants because no uniform tools are known that make it possible to combine different aspects to yield the product, and thus to provide documentation.

### SUMMARY OF THE INVENTION

In the method according to the present invention for automatically producing documentation for a project, at least one architecture description, which describes an architecture of the project having individual architecture elements, and detailed descriptions of the architecture elements are integrated using a configuration management tool.

Using this method, thorough documentation is provided for the project, which may also be a product. In this documentation, the at least one architecture description, i.e., at least one piece of architecture information, and detailed descriptions are integrated. The architecture elements may include different software elements such as modules, functions, structs, enums (decision tree method), APIs (application and/or programming interfaces), variables, documents, models, design information, file codes, and the like.

In producing or developing the product, for example a software product, the software elements change due to revisions, reworks, and transfers which accompany the development. The software elements may therefore be present as dynamic, i.e., non-static, files. At a certain point in time during the production, each of the software elements of the product may be present in its own version. This reflects the fact that some software elements are to be modified more intensively or more frequently than other software elements.

The configuration management tool may be designed as a tool or a program for managing and/or monitoring the version of all software elements present in the product at different points in time in different versions. Using this configuration management tool, relationships between the software elements, possibly also considering different versions of at least one particular software element, are organized as a function of time.

For testing the product, an overall version of the product present at a certain point in time must be frozen. The product is tested in a certain state which exists statically at this point in time. All software elements present at this point in time in their most recent versions are then taken into account. Further future changes and thus versions to be updated are ignored.

Using the configuration management tool, it is therefore possible to automatically provide the updated documentation adapted to the overall version of the product at the particular point in time. The design information and architecture information, coming from different sources or software inventories and also present in different versions, are automatically integrated. The most up-to-date version of a software element does not necessarily have to be used; depending on the requirement, an older version may be better suited for certain requirements. Within the overall product, a software element may therefore be present in at least one version, different versions of these software elements being related to or interacting with other different software elements.

In the method for producing documentation for a project, in one possible specific embodiment, a frame having at least one architecture description of the project may be generated using a code generator. The at least one architecture description may describe structural relationships or correlations between architecture elements.

Furthermore, detailed descriptions of individual architecture elements for the project may be inserted into the frame.

Furthermore, detailed descriptions may be mixed with one or more architecture descriptions. Manually editable areas of the documentation may then be preserved unchanged.

In an embodiment of the method, the detailed descriptions are transferred by the code generator from a first location of the documentation or the frame to a second location of the documentation or the frame and inserted or mixed into this second location, possibly with a slight modification of the method. For this purpose, the detailed descriptions are to be cut or copied from the first location.

It is furthermore possible to generate patterns for detailed descriptions of the method, for example with the aid of the code generator. The production or generation of the documentation is thus additionally facilitated.

The documentation is generated automatically during the execution of the method. It is furthermore possible to execute the method simultaneously with the development of the project or product. In this case, the documentation may be updated during a production process of the project at least from time to time or section by section, for example, at suitable fixed points in time or after suitable, fixed time periods. The documentation thus produced or generated is adjusted to the project and is therefore always up-to-date.

A document of a particular version and conforming to a template may be provided within the documentation for at least one architecture element designed as a module. Such documentation may also be provided, however, for other architecture elements such as functions, structs and the like.

The method is well-suited preferably for producing up-to-date documentation for software products. The documentation may be produced simultaneously with providing or programming such a software product. Programmers and developers are thus always provided with a structured and clearly understandable overview of the particular development status of a software project or software product.

In the documentation according to the present invention for a project, at least one architecture description, which describes a project architecture having individual architecture elements, and detailed descriptions of the architecture elements are automatically integrated using a configuration management tool.

This documentation documents detailed descriptions of individual architecture elements of the project. Furthermore, structural relationships or correlations between individual architecture elements are reflected in the documentation.

In an embodiment, the documentation according to the present invention for a project is produced using a code generator. A frame having at least one architecture description may be generated for the project, for example by this code generator, the detailed descriptions of individual architecture elements for the project being inserted in the frame.

Using this documentation, detailed descriptions of individual architecture elements of the project, which may also be a product, may be documented.

The documentation is preferably based on the HTML format or any other application suitable therefor in a graphic environment.

The method may be executed simultaneously with the project, so that the documentation is produced simultaneously with the project. The project may be version-controlled. The present invention provides a consistent tool which combines both architecturals and detailed software descriptions. A relationship between architecture and design is transient. A consistent document may thus be automatically generated, where a detail in the software may be modified without affecting the architecture.

Projects designed as complex and ambitious software environments are generated separately by the at least one architecture description and multiple detailed descriptions of individual modules. An architecture for the project or product is then developed, for example, with the aid of a UML tool and possibly a code is also generated. An existing implementation may be preserved while generating such a code. Parts of the same information from the at least one architecture description are repeated in the detailed documentation in order to thus describe the context and the interfaces. The architecture may be regularly applied across projects and therefore does not necessarily need to differ between different projects. In contrast, architecture elements such as software modules almost always differ from one project to another. Therefore, detailed descriptions are applied in a version control system together with a code with the aid of MKS, ClearCase, as an example of a configuration management tool, cvs, and the like.

Using the method according to the present invention and the documentation according to the present invention, the at least one architecture description and the detailed descriptions are automatically integrated. In complex software environments, a large number of combinations between architecture variants and module variants, i.e., versions, are common. All these combinations are dynamically taken into account in the automatically generated documentation. Ideally, the documentation is compiled from all module versions and the particular architecture used. A user of the documentation is able to easily find his way in the clearly structured architecture and thus “make his way hand over hand,” whereby he is guided to a desired piece of information or detailed description. Within the documentation, certain APIS, enums, variables, or other architecture elements are accessible via mouse clicks and search functions. Because it is automatically generated, the documentation is always up-to-date. A comprehensive single-source concept exists for the documentation.

The project or product may also be a complex system such as a motor vehicle or an electromechanical device having a variety of different functions. Such systems usually have a plurality of interacting components or modules. A system development or production may be accompanied using the method according to the present invention. It is also conceivable to provide operating instructions for this system based on the documentation.

The computer program according to the present invention having program code means is designed for executing all steps of the method according to the present invention when this computer program is executed on a computer or an appropriate processor.

The computer program according to the present invention having program code means which are stored on a computer-readable data medium is provided for executing all steps of the method according to the present invention when this computer program is executed on a computer or an appropriate processor.

### BRIEF DESCRIPTION OF THE DRAWINGS

FIG. 1 schematically shows a first specific embodiment of documentation having individual components.

FIG. 2 schematically shows a preferred specific embodiment of a description of a module.

FIG. 3 schematically shows another specific embodiment of documentation.

FIG. 4 schematically shows a diagram of a preferred execution of a method.

### DETAILED DESCRIPTION

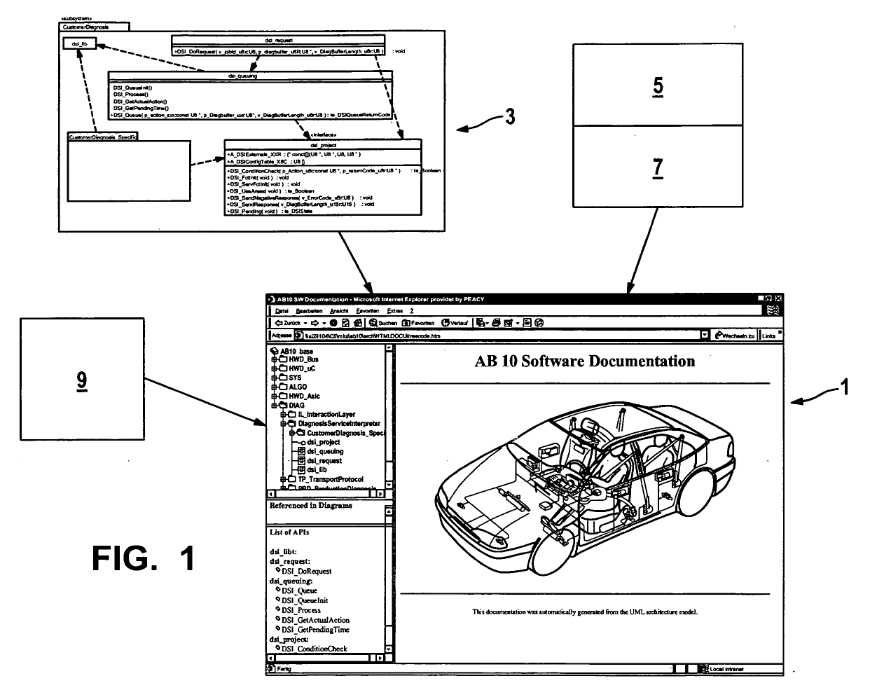

FIG. 1 schematically shows a first specific embodiment of documentation 1 embedded into a user interface. It is provided that this documentation 1 arises during production in a possible variant of the method according to the present invention from a plurality of components 3, 5, 7, 9. A project selection 3 affects documentation 1. Detailed descriptions 9 are provided from an MKS library in the present first specific embodiment. Furthermore, a QRP script 5 is provided, which allows diagrams and reference lists for diagrams to be generated. Using a C code generator 7 as a component of a C compiler, for example an ACD code generator, a design is produced for documentation 1.

In this case, the result is documentation 1 in HTML format. For each architecture element or module, there is a document in a certain version and conforming to a template, from which detailed descriptions 9 are imported into final documentation 1. In this case, detailed descriptions 9 are also HTML-based. Regions within documentation 1, which are to be edited, are marked accordingly and provided with unambiguous identifiers which associate a certain piece of information with a particular architecture element. In this specific embodiment, these identifiers are hidden behind HTML comments. A template, which provides an author or a programmer with information where further detailed descriptions 9 or information are to be entered while producing a project or product for which documentation 1 is intended, may thus be produced from an architecture model.

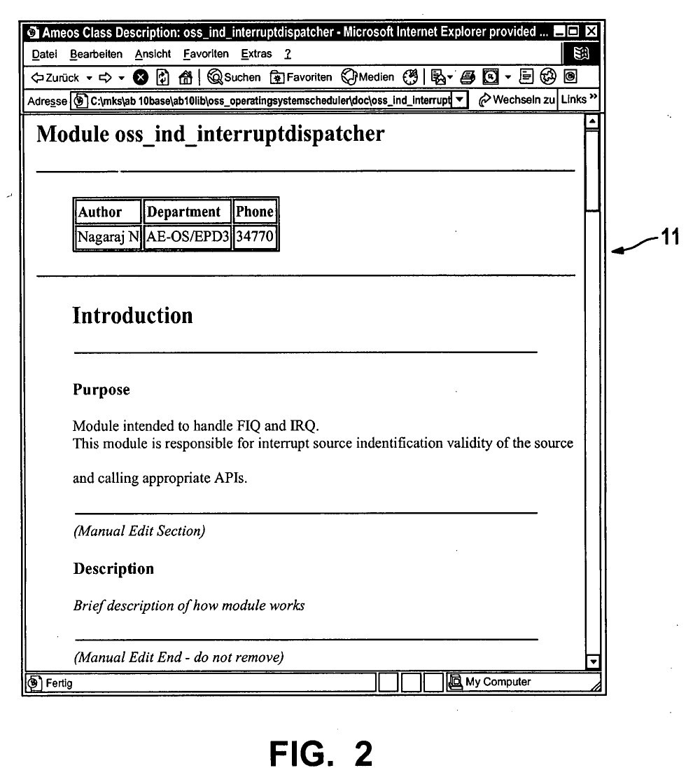

FIG. 2 schematically shows a specific embodiment of an architecture element which is designed as a module 11. A description of this module 11 oss_ind_interruptdispatcher is required here. This description must occur between the text locations “Manual Edit Section” and “Manual Edit Section End—do not remove” shown in italics. Such regions are influenced by a function, for example. Details or information are entered into a corresponding template to a not yet sufficient extent.

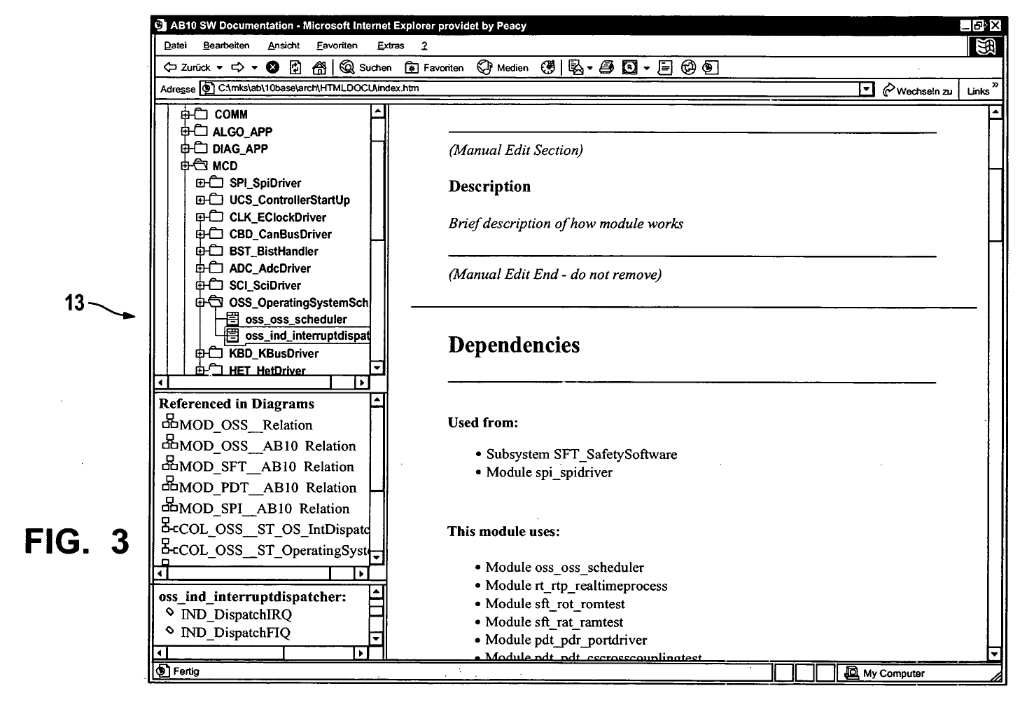

In a final documentation 13, which is illustrated in a possible specific embodiment in FIG. 3, the detailed description is then imported into a fully linked page which refers to a particular module.

In this case, the detailed description is not yet completed. All elements integratable via HTML such as images, animations, and the like may be used. The embedded page is not only a pattern, but also includes links and dynamic architecture descriptions.

Such documentation 13, which contains architecture descriptions and detailed descriptions, may also be provided to future users of a product or system, i.e., customers, in addition to programmers and authors. In an environment made up of different projects and their versions, the method provides an automated process for preparing the documentation.

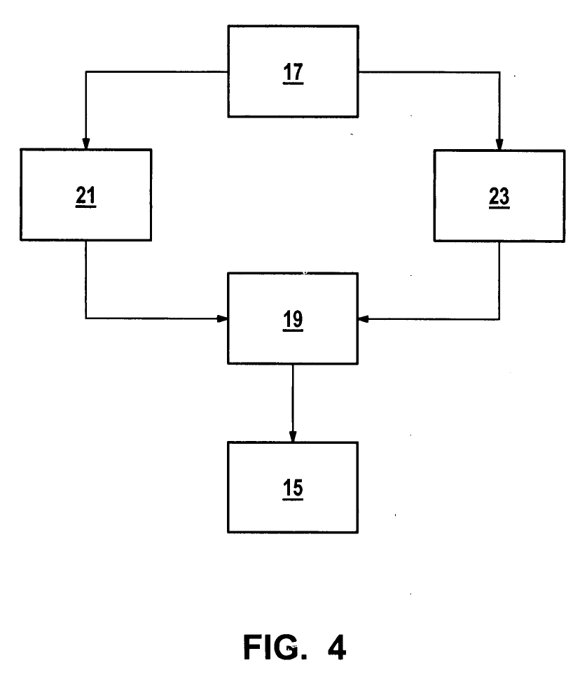

FIG. 4 schematically shows a diagram for running a method for producing documentation 15 for a project 17, in which an architecture description, which describes an architecture for project 17 having individual architecture elements, and detailed descriptions 23 of individual architecture elements are integrated from individual architecture elements to yield product 17.

In this variant for generating documentation 15, code generator 19 is used, at least in part, using which a frame 21 is produced for the architecture description and detailed descriptions are inserted into this frame. Code generator 19 allows hand-editable regions to be preserved and description fragments from another location to be mixed in while slightly modifying the method. Frame 21 containing all architecture descriptions is generated. Detailed descriptions 23 of the architecture elements such as modules, functions, APIs, structs, and enums are also mixed in from detailed documents. Patterns for the detailed descriptions are also generated. Documentation 15 thus produced is individually adjusted to project 17 and is always up-to-date.

The method may be used, for example, in a project 17, product, or system for an automotive application, a number of control units for an airbag, for example, interacting with one another. The documentation produced by the method may also accompany the development of a complex system such as a motor vehicle which has a plurality of individual components. An operating instruction is to be provided for a future user of the system on the basis of the documentation.

1-13. (canceled)

14. A method for automatically producing documentation for a project, the method comprising:
integrating, using a configuration management tool, at least one architecture description, which describes an architecture of the project, having individual architecture elements, and detailed descriptions of the architecture elements.

15. The method according to claim 14, further comprising generating a frame having the at least one architecture description of the project.

16. The method according to claim 14, wherein the method is executed simultaneously with a development of the project.

17. The method according to claim 14, further comprising preserving hand-editable regions of the documentation.

18. The method according to claim 14, further comprising inserting detailed descriptions from a first location into a second location of the documentation.

19. The method according to claim 14, further comprising generating patterns for the detailed descriptions.

20. The method according to claim 14, further comprising providing a document of a particular version and conforming to a template for each architecture element designed as a module.

21. A documentation for a project, comprising:
a configuration management tool for automatically integrating at least one architecture description, which describes an architecture of the project, having individual architecture elements, and detailed descriptions of the architecture elements.

22. The documentation according to claim 21, wherein the documentation documents detailed descriptions of individual architecture elements of the project.

23. The documentation according to claim 21, wherein the documentation reflects relationships between individual architecture elements.

24. The documentation according to claim 21, wherein the documentation is based on the HTML format.

25. A computer-readable medium containing a computer program which when executed by a processor performs the following method for automatically producing documentation for a project:
integrating, using a configuration management tool, at least one architecture description, which describes an architecture of the project, having individual architecture elements, and detailed descriptions of the architecture elements.
